(19) United States
(12) Patent Application Publication
(10) Pub. No.: US 2025/0209590 A1
(43) Pub. Date: Jun. 26, 2025

(54) METHOD OF PROVIDING CLASSIFICATION INFORMATION ON IRON SCRAPS ACCORDING TO UNLOADING PROCESS AND IRON SCRAP CLASSIFICATION APPARATUS

(71) Applicants: LG CNS CO., LTD., Seoul (KR); DaehanSteel, Busan (KR)

(72) Inventors: Hee Jae LEE, Seoul (KR); Won Young LEE, Seoul (KR); Sang Jeong LEE, Seoul (KR); Chang Hyun LEE, Busan (KR)

(21) Appl. No.: 18/991,133

(22) Filed: Dec. 20, 2024

(30) Foreign Application Priority Data
Dec. 21, 2023 (KR) 10-2023-0188834

(51) Int. Cl. G06T 7/00; G06T 7/11; G06T 7/593; G06V 10/25; G06V 10/26; G06V 10/75; G06V 10/764; G06V 20/50

(52) U.S. Cl. CPC G06T 7/0002; G06T 7/11; G06T 7/593; G06V 10/25; G06V 10/26; G06V 10/751; G06V 10/764; G06V 20/50; G06T 2207/10012; G06T 2207/30136; G06V 2201/06

(57) ABSTRACT

A method of providing classification information for iron scraps includes receiving, by a receiving circuit, a loaded state image during an unloading process of multiple iron scraps loaded onto a loading device, and, by a processor, obtaining layer information that is updated as the unloading process progresses and determined based on a height of the multiple iron scraps determined in a stack direction of the multiple iron scraps, determining a region of interest based on the loaded state image that is updated as the unloading process progresses, generating a segmented image of a target iron scrap, included in the region of interest, generating item information and grade information for the target iron scrap based on the segmented image and the layer information, and providing classification information for the iron scraps, including the item information and the grade information. The target iron scrap is one of the multiple iron scraps.

### CROSS-REFERENCE TO RELATED APPLICATION

The present application claims priority to and the benefit of Korean Patent Application No. 10-2023-0188834, filed on Dec. 21, 2023, the disclosure of which is incorporated herein by reference in its entirety.

### BACKGROUND

### 1. Field of the Invention

The technical field of the present disclosure relates to a method of providing result information on image classification based on a process for unloading objects loaded onto a loading device, a single object, or the like, and more particularly, relates to a method of providing classification information on iron scraps through image analysis of a region where one or more iron scraps are unloaded.

### 2. Background

Recently, with the growth of the logistics industry, loading devices are being widely used to load various objects or move objects from one place to another place. Typically, the placement of objects loaded onto a loading device is determined by workers based on product type or specifications. However, manually verifying the positions of the objects can be challenging and inefficient. To address this, a segmentation method is often employed, where an entire region of the loading device onto which the objects are loaded is divided into a plurality of regions, and images of the regions are monitored.

Generally, in image analysis methods for iron scrap segmentation, an optical system can be easily installed at unloading positions to obtain images without hardware (H/W) engineering to set the position and angle of the optical system (e.g., closed-circuit television (CCTV) and mechanism) for optimal artificial intelligence (AI) performance. However, this approach faces limitations due to the need for extensive image collection and labeling. These challenges arise from the irregular nature of iron scrap, which exhibits inconsistent features such as various shapes (depending on usage), plain textures, various colors (e.g., paint, rust, etc.), and different cutting and bending methods. Instance segmentation, often used to classify such irregular scrap and determine its grade, requires significant effort for data preparation. Therefore, there is a need for an improved image analysis method and system that enhances performance while reducing the amount of image collection and labelling required.

### SUMMARY OF THE INVENTION

The present disclosure is directed to providing a technique for improving the accuracy of image analysis and classification for one or more objects (e.g., iron scraps) in a loaded state image. The technique enables the provision of high-accuracy image classification information for the objects based on an unloading process. It also facilitates obtaining a segmented image of a region determined as an unloading region from a loaded state image captured during the unloading process, and subsequently providing high-accuracy image classification information for the segmented image.

The objectives of the present disclosure are not limited to the above-described purpose, and additional technical objectives may also be addressed.

According to an aspect of the present disclosure, there is provided a method of providing classification information on iron scraps according to an unloading process, which includes obtaining, by a receiving unit, a loaded state image captured during an unloading process of a plurality of iron scraps loaded onto a loading device, obtaining, by a processor, layer information that is updated as the unloading process progresses and determined according to a height of the plurality of iron scraps, determining, by the processor, a region of interest on the basis of the loaded state image that is updated as the unloading process progresses, obtaining, by the processor, a segmented image of target iron scrap, which is included in the region of interest and is any one of the plurality of iron scraps, obtaining, by the processor, item information and grade information on the target iron scrap on the basis of the segmented image and the layer information, and providing, by the processor, classification information on the iron scraps that includes the item information and the grade information.

A method of obtaining the layer information may include a mono type method in which one camera is used or a stereo type method in which two or more cameras are used, and in the mono type method, depth information obtained through analysis of changes in wall surface of a loading box obtained from an image obtained by the one camera may be used.

The determining of the region of interest may include determining, by the processor, the region of interest on the basis of a result of comparing a first loaded state image corresponding to a first time point with a second loaded state image corresponding to a second time point that is temporally later than the first time point.

The determining of the region of interest may include determining, by the processor, the region of interest on the basis of a difference region between the first loaded state image and the second loaded state image and an operation region of a grapple used in the unloading process.

The obtaining of the segmented image by the processor may include obtaining the segmented image including the target iron scrap from the loaded state image using a segmentation model, and the obtaining of the item information and the grade information by the processor may include obtaining the item information and the grade information that correspond to the target iron scrap using a classification model that performs analysis in units of images.

The obtaining of the segmented image may include performing, by the processor, instance segmentation on the loaded state image and obtaining the segmented image of a single object, and performing, by the processor, semantic segmentation on the loaded state image and obtaining the segmented image of aggregate objects.

The obtaining of the segmented image of the aggregate objects may be performed on regions of the loaded state image, from which a region corresponding to the single object is excluded.

In the stereo type method, the depth information obtained through analysis of changes in angles obtained from images for the same region that are obtained from the two or more cameras positioned on the same plane may be used.

The second time point may be determined based on whether the grapple is included in any partial region of regions of a vertical direction of the loading device after the first time point, and the determining of the region of interest may include, when the grapple is included in the partial region for a preset period of time or more, determining, by the processor, the region of interest on the basis of an operating state of the grapple that indicates whether the grapple includes at least one iron scrap.

The obtaining of the layer information may include obtaining, by the processor, a first layer change time point at which the height of the plurality of iron scraps are changed to a critical height or more on the basis of the depth information obtained according to the stereo type method, obtaining, by the processor, a second layer change time point at which a volume of the plurality of iron scraps are changed to a critical percentage or more on the basis of an average volume of the loading device, and obtaining, by the processor, the layer information at least one of the first layer change time point and the second layer change time point.

According to another aspect of the present disclosure, there is provided an iron scrap classification apparatus for providing classification information on iron scraps according to an unloading process, which includes a receiving unit configured to obtain a loaded state image captured during an unloading process of a plurality of iron scraps loaded onto a loading device, and a processor that is configured to obtain layer information that is updated as the unloading process progresses and determined according to a height of the plurality of iron scraps, determine a region of interest on the basis of the loaded state image that is updated as the unloading process progresses, obtain a segmented image of target iron scrap, which is included in the region of interest and is any one of the plurality of iron scraps, obtain item information and grade information on the target iron scrap on the basis of the segmented image and the layer information, and provide classification information on the iron scraps that includes the item information and the grade information.

A method of obtaining the layer information may include a mono type method in which one camera is used or a stereo type method in which two or more cameras are used, and in the mono type method, depth information obtained through analysis of changes in wall surface of a loading box obtained from an image obtained by the one camera may be used.

The processor may determine the region of interest on the basis of a result of comparing a first loaded state image corresponding to a first time point with a second loaded state image corresponding to a second time point that is temporally later than the first time point.

The processor may determine the region of interest on the basis of a difference region between the first loaded state image and the second loaded state image and an operation region of a grapple used in the unloading process.

According to still another aspect of the present disclosure, there is provided a computer-readable non-transitory recording medium on which a program for implementing the method of the first aspect is recorded.

### BRIEF DESCRIPTION OF THE DRAWINGS

The above and other aspects, features and advantages of the present disclosure will become more apparent to those of ordinary skill in the art by describing exemplary embodiments thereof in detail with reference to the accompanying drawings, in which:

FIG. 1 is a block diagram schematically illustrating an iron scrap classification apparatus for providing classification information on iron scraps according to an embodiment of the present disclosure;

FIG. 2 is a flowchart illustrating operations in which the iron scrap classification apparatus according to an embodiment of the present disclosure provides classification information on iron scraps based on an unloading process;

FIG. 3 is a diagram illustrating an example in which the iron scrap classification apparatus according to an embodiment of the present disclosure generates layer information by utilizing a mono type method;

FIG. 4 is a diagram illustrating an example in which the iron scrap classification apparatus according to an embodiment of the present disclosure generates layer information by utilizing a stereo type method;

FIG. 5 is a diagram illustrating an example in which the iron scrap classification apparatus according to an embodiment of the present disclosure uses depth information;

FIG. 6 is a diagram illustrating an example in which the iron scrap classification apparatus according to an embodiment of the present disclosure determines a region of interest based on whether a grapple is included in any partial region of regions of a vertical direction of a loading device;

FIG. 7 is a diagram illustrating an example in which the iron scrap classification apparatus according to an embodiment of the present disclosure obtains a grapple operation region;

FIG. 8 is a diagram illustrating an example in which the iron scrap classification apparatus according to an embodiment of the present disclosure generates layer information using a mono type method and obtains an unloading region based on a grapple operation region;

FIG. 9 is a diagram illustrating an example in which the iron scrap classification apparatus according to an embodiment of the present disclosure generates layer information for each layer change time point using a stereo type method;

FIG. 10 is a diagram illustrating an example in which the iron scrap classification apparatus according to an embodiment of the present disclosure performs semantic segmentation and instance segmentation;

FIG. 11 is a diagram illustrating an example in which the iron scrap classification apparatus according to an embodiment of the present disclosure further obtains segmented images for aggregate objects for a region from which a region corresponding to a single object is excluded; and

FIG. 12 shows a simplified diagram of a device that corresponds to the apparatus illustrated in FIG. 1, according to an embodiment of the present disclosure.

### DETAILED DESCRIPTION OF EXEMPLARY EMBODIMENTS

A detailed description of embodiments is provided below along with accompanying figures. The scope of this disclosure is limited by the claims and encompasses numerous alternatives, modifications and equivalents. Although steps of various processes are presented in a given order, embodiments are not necessarily limited to being performed in the listed order. In some embodiments, certain operations may be performed simultaneously, in an order other than the described order, or not performed at all.

Terms used herein are provided only to describe the embodiments of the present disclosure and not for purposes of limitation. In this specification, the singular forms include the plural forms unless the context clearly indicates otherwise. It will be understood that terms “comprise” and/or “comprising” used herein specify some stated components, but do not preclude the presence or addition of one or more other components. Like reference numerals throughout the specification denote like components, and “and/or” includes each and every combination of one or more of the above-describe components. It should be understood that, although the terms “first,” “second,” etc. may be used herein to describe various components, these components are not limited by these terms. The terms are only used to distinguish one component from another component. Therefore, it should be understood that a first component to be described below may be a second component within the technical scope of the present disclosure.

Unless otherwise defined, all terms including technical and scientific terms used herein have the same meaning as commonly understood by those skilled in the art. Further, it should be further understood that terms, such as those defined in commonly used dictionaries, should not be interpreted in an idealized or overly formal sense unless expressly so defined herein.

Spatially relative terms “below,” “beneath,” “lower,” “above,” “upper,” etc., may be used to facilitate the description of a relationship between one component and other components as illustrated in the accompanying drawings. The spatially relative terms should be understood to include different directions of the element during use or operation in addition to the direction illustrated in the accompanying drawings. For example, when a component illustrated in the drawing are flipped, a component described as “below” or “beneath” another component may end up being placed “above” the other component. Therefore, an exemplary term “below” may include both downward and upward directions. Components may be arranged in different directions so that spatially relative terms may be interpreted according to the arrangement.

Hereinafter, embodiments will be described in detail with reference to the accompanying drawings.

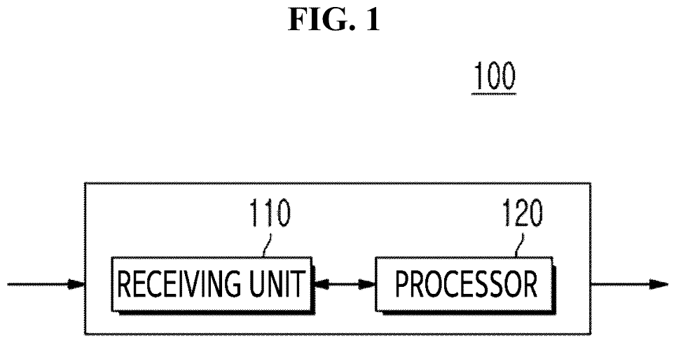

FIG. 1 is a block diagram schematically illustrating an iron scrap classification apparatus 100 for providing classification information on objects according to an embodiment of the present disclosure. In one embodiment, the objects may include iron scraps. For example, the following description will provide iron scraps as the objects to be classified.

Referring to FIG. 1, the iron scrap classification apparatus 100 may include a receiving circuit (or unit) 110 and a processor 120.

According to an embodiment, the receiving circuit 110 may obtain a loaded state image captured during an unloading process of a plurality of iron scraps loaded onto a loading device. In an embodiment, the receiving circuit 110 may receive the loaded state image as electrical signal such as analog or digital signals.

The processor 120 may obtain layer information that is updated as the unloading process progresses, which is determined based on the height of the plurality of iron scraps in a stack direction of the plurality of iron scraps loaded onto the loading device. Further, the processor 120 may determine a region of interest on the basis of the loaded state image, which is updated as the unloading process progresses. Further, the processor 120 may then obtain a segmented image of a target iron scrap that is included in the region of interest, wherein the target iron scrap is one of the plurality of iron scraps. Further, the processor 120 may generate item information and grade information for the target iron scrap on the basis of the segmented image and the layer information. Further, the processor 120 may provide classification information for the iron scraps, including the item information and the grade information.

Further, the apparatus 100 may be integrated with various conventional networks, such as the Internet, a mobile communication network, etc. These networks can be utilized during the process in which the receiving circuit 110 obtains the loaded state image, and the processor 120 obtains the layer information based on the height of the plurality of iron scraps, determines the region of interest on the basis of the loaded state image, obtains the segmented image of the target iron scrap, and provides the classification information for the iron scraps. It should be noted that there is no special limitation regarding the types of networks that can be used.

In addition, it should be understood by those skilled in the art that other general components other than those illustrated in FIG. 1 may be further included in the apparatus 100. For example, the apparatus 100 may further include a memory (not illustrated) that stores the loaded state image, the layer information, the region of interest, the segmented image, the item information and grade information that correspond to the segmented image, etc., and may further include a transmitting circuit (not illustrated) that transmits the classification information for the iron scraps or a display circuit (not illustrated) that displays the classification information for the iron scraps. Alternatively, it will be understood by those skilled in the art that in another embodiment, some of the components illustrated in FIG. 1 may be omitted.

The apparatus 100 may be used by a user, may be linked with any type of handheld-based wireless communication devices equipped with a touch screen panel, such as a mobile phone, a smartphone, a personal digital assistant (PDA), a portable multimedia player (PMP), a tablet computer, etc. Additionally, the apparatus 100 may be integrated with or connected to a device capable of installing and running applications, such as a desktop personal computer (PC), a tablet computer, a laptop computer, an Internet Protocol television (IPTV) with a set-top box, or the like.

The apparatus 100 may be implemented as a terminal such as a computer or the like that operates through a computer program to realize the functions described in this specification.

The apparatus 100 may include a system (not illustrated) that provides classification information for iron scraps and a related server (not illustrated), but the present disclosure is not limited thereto. According to an embodiment, the server may support an application that provides classification information for iron scraps.

Hereinafter, an example is described in which the apparatus 100 independently obtains and provides classification information based a preset classification method. However, as described above, the apparatus 100 may perform the above function in conjunction with the server. Specifically, the apparatus 100 and the server may be functionally integrated, or the server may be omitted. Accordingly, the present disclosure is not limited to any particular embodiment.

In an embodiment, the iron scrap classification apparatus 100 and the server may be linked with each other to perform an iron scrap classification process and a classification result information provision process, a configuration for providing the classification information on the iron scraps may be performed by the server or by the iron scrap classification apparatus 100. For example, the iron scrap classification apparatus 100 may operate as a server, and the iron scrap classification apparatus 100 and the server are hereinafter collectively referred to as the iron scrap classification apparatus 100.

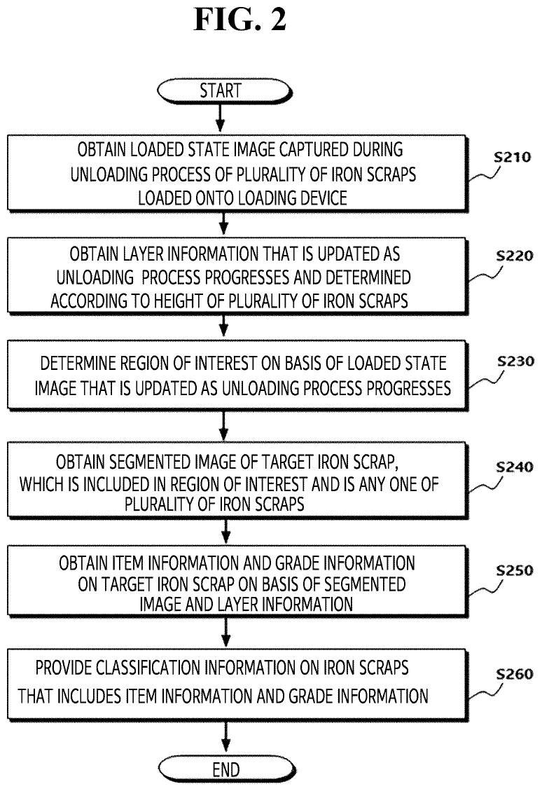

FIG. 2 is a flowchart illustrating respective operations in which the iron scrap classification apparatus 100 provides classification information for iron scraps according to an unloading process.

Referring to operation S210, the iron scrap classification apparatus 100 may obtain a loaded state image captured during an unloading process of a plurality of iron scraps loaded onto a loading device. In an embodiment, the iron scrap classification apparatus 100 may receive, by the receiving circuit 110, the loaded state image captured above the loading device, looking down at it, and in this case, the plurality of iron scraps are being loaded onto the loading device. Further, the loaded state image is an image obtained during the unloading process, and may include an image after one or more iron scraps are unloaded and/or an image before the one or more iron scraps are unloaded over time during the unloading process. Therefore, the iron scrap classification apparatus 100 may obtain a loaded state image including a plurality of iron scraps during the unloading process of the one or more iron scraps.

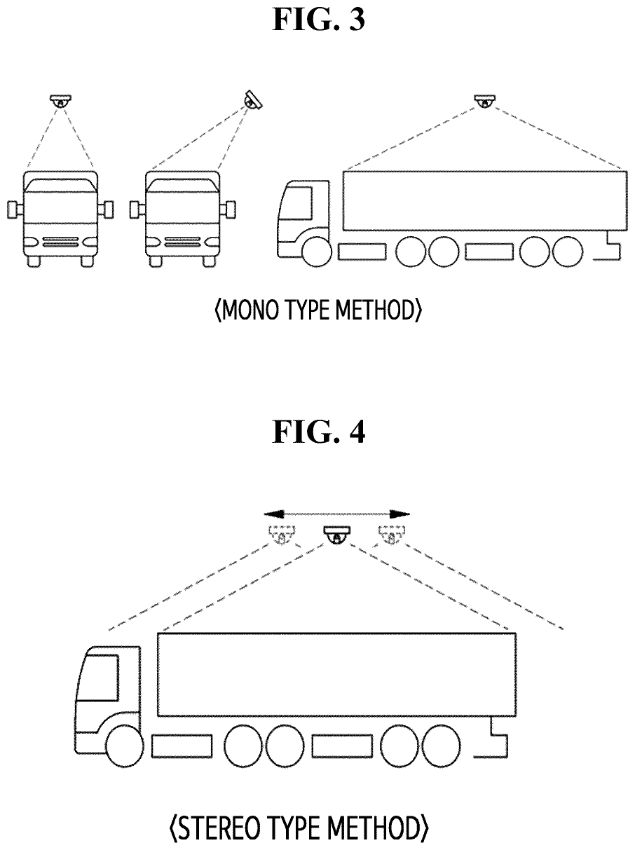

Referring to operation S220, the iron scrap classification apparatus 100 may obtain layer information that is updated as the unloading process progresses and determined according to the height of the plurality of iron scraps. In an embodiment, the layer information may be information on the height of the plurality of iron scraps that is changed over time during the unloading process. The layer information may include position change information and/or height change information for the plurality of iron scraps that are updated as the one or more iron scraps are unloaded from the loading device. In an embodiment, a method of obtaining the layer information may include a mono type method in which one camera is used or a stereo type method in which two or more cameras are used. This will be described with reference to FIGS. 3 to 5.

FIG. 3 is a diagram illustrating an example in which the iron scrap classification apparatus 100 obtains layer information on the basis of the mono type method.

Referring to FIG. 3, in the mono type method, depth information obtained through analysis of changes in wall surface of a loading box obtained from an image obtained by one camera may be used. For example, the iron scrap classification apparatus 100 may obtain the depth information indicating the height of a plurality of iron scraps in the loading device according to changes in wall surface of the loading box on the basis of loaded state images captured in a vertical direction and/or one or more lateral directions while one camera moves.

FIG. 4 is a diagram illustrating an example in which the iron scrap classification apparatus 100 obtains layer information on the basis of the stereo type method.

Referring to FIG. 4, in the stereo type method, depth information obtained through analysis of changes in angles obtained from images for the same region may be used, wherein the images are obtained by two or more cameras positioned on the same plane. For example, the iron scrap classification apparatus 100 may obtain the depth information indicating the height of the plurality of iron scraps in the loading device according to changes in images according to changes in angles for the same region in a plurality of loaded state images captured in the vertical direction from two or more cameras positioned on the same plane.

The iron scrap classification apparatus 100 may obtain the layer information based on the depth information, which is obtained based on the mono type method and/or the stereo type method using an artificial intelligence (AI) model. Specifically, the iron scrap classification apparatus 100 may perform analysis on changes in wall surface of the loading box using the mono type method, and may perform analysis on changes in images according to the changes in angles using the stereo type method. Therefore, the iron scrap classification apparatus 100 obtains the layer information on the basis of the depth information according to the changes in wall surface of the loading box and the depth information according to the changes in images of a region corresponding to the same region in the loaded state image, and uses the layer information for image analysis, and thus the accuracy of the analysis can be improved. That is, limitations such as light reflection, shaking, and the like that may occur in the mono type method in which one camera is used may be supplemented through the stereo type method in which two or more cameras are used.

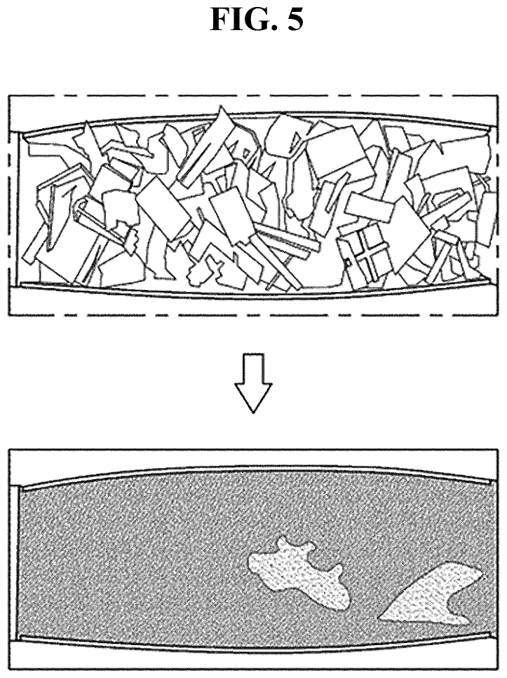

FIG. 5 is a diagram illustrating an example in which the iron scrap classification apparatus 100 uses depth information.

Referring to FIG. 5, a loaded state image shown at an upper part of the drawing is an image obtained using the mono type method, and the iron scrap classification apparatus 100 may obtain a loaded state image captured in a vertical direction using an AI model. Further, a loaded state image captured in a lateral direction may be further obtained. Therefore, it is possible to perform analysis on changes in wall surface of a loading box on the basis of the loaded state images captured in the vertical and lateral directions.

For example, a region with a large change in wall surface of the loading box may be a region with a shallow depth, and a region with a small change in wall surface of the loading box may be a region with a deep depth. The iron scrap classification apparatus 100 may obtain a depth map showing the height or height change of the plurality of iron scraps as shown at a lower part of the drawing. As illustrated in FIG. 5, each of the plurality of iron scraps regions may be represented by different colors or different hatching regions according to the depth. That is, the denser the hatching density, the deeper the region may be represented. Therefore, the iron scrap classification apparatus 100 may obtain layer information including layer changes using depth information of the depth map.

Referring to operation S230, the iron scrap classification apparatus 100 may determine a region of interest on the basis of the loaded state image that is updated as the unloading process progresses. In an embodiment, the updated loaded state image may be an image after one or more iron scraps has been unloaded as the unloading process progresses, and an unloading region may correspond to the region of interest. In an embodiment, the iron scrap classification apparatus 100 may determine the region of interest on the basis of a result of comparing a first loaded state image corresponding to a first time point with a second loaded state image corresponding to a second time point that is temporally later than the first time point. For example, the first loaded state image may correspond to an image before the one or more iron scraps are unloaded, and the second loaded state image may correspond to an image after the one or more iron scraps are unloaded.

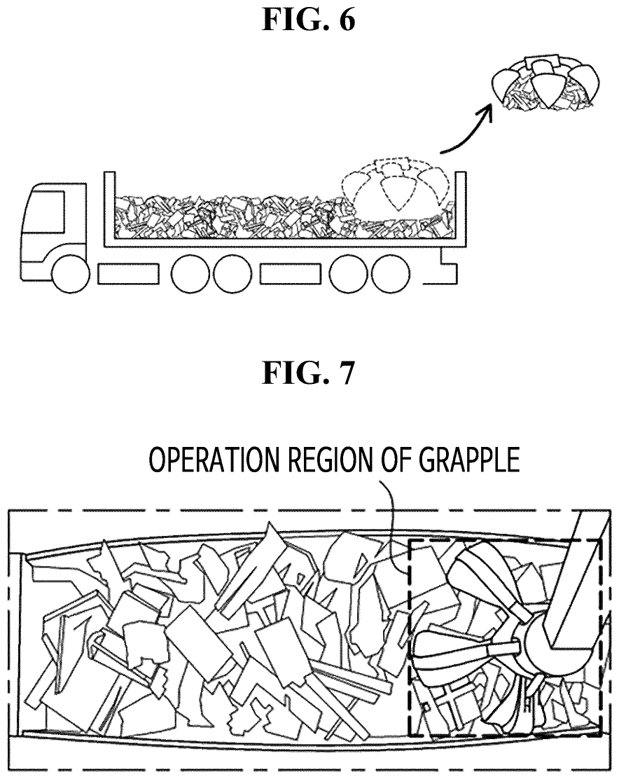

FIG. 6 is a diagram illustrating an example in which the iron scrap classification apparatus 100 determines a region of interest based on whether a grapple is included in any partial region of regions of a vertical direction of a loading device.

Referring to FIG. 6, in an embodiment, during an unloading process for one or more iron scraps, a partial region of a vertical direction of the loading device that includes a grapple may be determined to be the region of interest. For example, the partial region corresponding to a case in which the grapple satisfies the condition of appearing or disappearing above the loading device (the region of the vertical direction) may be determined to be the region of interest.

FIG. 7 is a diagram illustrating an example in which the iron scrap classification apparatus 100 obtains a grapple operation region.

Referring to FIG. 7, the iron scrap classification apparatus 100 may obtain a grapple operation region of an image including a grapple from a plurality of loaded state images captured during an unloading process. The iron scrap classification apparatus 100 may identify the grapple from the loaded state images using an AI model. As illustrated in FIG. 7, the grapple may be identified and the grapple operation region may be obtained. For example, the iron scrap classification apparatus 100 may obtain a certain region including the boundary of the grapple as the grapple operation region. Therefore, the iron scrap classification apparatus 100 may determine a partial region including the grapple operation region to be the region of interest. The iron scrap classification apparatus 100 may determine a partial region corresponding to the grapple operation region among difference regions between a first loaded state image and a second loaded state image to be the region of interest. The iron scrap classification apparatus 100 may compare and analyze a difference in image between a region of interest corresponding to the grapple operation region in the first loaded state image and a region of interest corresponding to the grapple operation region in the second loaded state image.

Referring to operation S240, the iron scrap classification apparatus 100 may obtain a segmented image of a target iron scrap that is included in the region of interest, wherein the target iron scrap is one of the plurality of iron scraps. The iron scrap classification apparatus 100 may obtain a segmented image including the target iron scrap from the loaded state image using a segmentation model. In an embodiment, the target iron scrap may be a target of image analysis. In order to classify the plurality of iron scraps included in the region of interest into one iron scrap, the iron scrap classification apparatus 100 may perform segmentation on iron scraps of any one region among a plurality of iron scrap regions to obtain a segmented image. In an embodiment, the segmented image may include a plurality of images.

For example, the iron scrap classification apparatus 100 may perform instance segmentation on the loaded state image to obtain a segmented image of a single object. Further, the iron scrap classification apparatus 100 may perform semantic segmentation on the loaded state image to obtain a segmented image of aggregate objects. In an embodiment, the semantic segmentation may be performed in units of pixels. For example, the iron scrap classification apparatus 100 may obtain a segmented region including one or more pixels corresponding to each of the plurality of iron scraps in units of pixels to obtain a segmented image, which is an image corresponding to each of segmented regions obtained in the region of interest.

Therefore, the segmented image may be a multi-concept that includes both a segmented image of a single object and a segmented image of aggregate objects. Semantic segmentation is segmentation performed by recognizing objects as physical semantic units that can actually be recognized and a segmented image of aggregate objects in which a plurality of objects are clustered may be obtained, and instance segmentation is segmentation performed by recognizing each object as a single unit and a segmented image of a single object may be obtained.

Referring to operation S250, the iron scrap classification apparatus 100 may obtain item information and grade information for the target iron scrap on the basis of the segmented image and the layer information. The iron scrap classification apparatus 100 may obtain the item information and grade information that correspond to the target iron scrap using a classification model that performs analysis in units of images. In an embodiment, the classification is a process of analyzing or classifying iron scraps according to feature information extracted from each image for each segmented image.

The iron scrap classification apparatus 100 may perform analysis on each of a plurality of segmented images in units of images using a classification model. Therefore, the iron scrap classification apparatus 100 may obtain item information and grade information that correspond to each analysis image. In an embodiment, the item information corresponds to feature information for iron scraps, and may include, for example, heavy weight iron scrap information, light weight iron scrap information, and the like.

Further, in an embodiment, the iron scrap classification apparatus 100 may perform classification on a target iron scrap image to obtain grade information corresponding to the target iron scrap. That is, the iron scrap classification apparatus 100 may obtain item information and grade information that correspond to each target iron scrap by performing classification.

Further, the iron scrap classification apparatus 100 may use layer information to perform classification. In an embodiment, the sizes of the plurality of iron scraps in the loaded state image may be different according to a layer. For example, for each of the plurality of iron scraps, the higher the loading height, the larger the size may appear in the loaded state image. In an embodiment, since the size of the iron scrap may be a factor affecting the item information or the grade information, the iron scrap classification apparatus 100 may also use depth information included in the layer information to obtain the item information and the grade information by performing classification on the segmented images. The depth information is a factor that can determine the height of each of the plurality of iron scraps, and may be a factor that indicates a more detailed height (depth) for determining a layer.

The iron scrap classification apparatus 100 may obtain the item information and the grade information for each of the plurality of iron scraps using a result of the classification and the depth information of each of the plurality of iron scraps included in the segmented image. Therefore, the iron scrap classification apparatus 100 may determine the item information and the grade information in more detail in consideration of the size of the iron scrap according to the height (depth) using not only the image obtained in a planar manner but also the depth information, and thus the accuracy of the item information and grade information for the iron scrap may be enhanced.

Referring to operation S260, the iron scrap classification apparatus 100 may provide classification information for iron scraps, which includes the item information and the grade information. The iron scrap classification apparatus 100 may provide the item information and the grade information for the target iron scrap that are obtained using the segmentation model and classification model, as described above, as the classification information for the iron scrap.

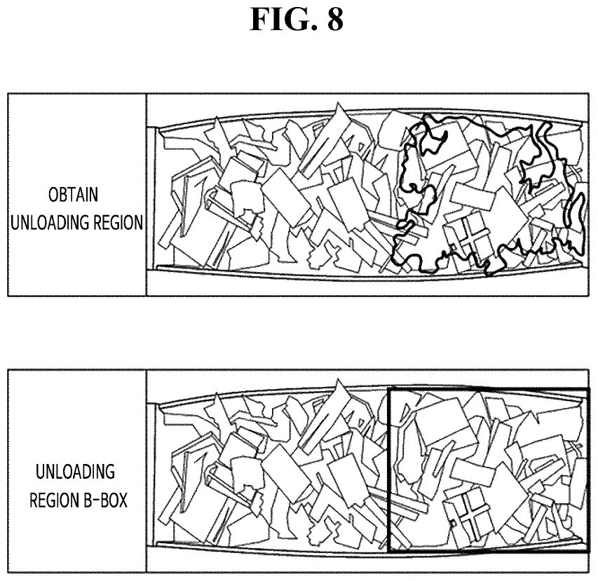

FIG. 8 is a diagram illustrating an example in which the iron scrap classification apparatus 100 obtains layer information using the mono type method and obtains an unloading region on the basis of a grapple operation region.

Referring to FIG. 8, the iron scrap classification apparatus 100 may obtain a region of interest or difference region of each of a first loaded state image and a second loaded state image as the unloading region on the basis of the grapple operation region described in FIG. 7. Specifically, the iron scrap classification apparatus 100 may obtain the difference region between the first loaded state image representing a loaded state image before one or more iron scraps are unloaded and the second loaded state image representing a loaded state image after the one or more iron scraps are unloaded, measure changes in the difference region, identify the unloading region, and determine a more accurate region of interest.

The iron scrap classification apparatus 100 may identify the unloading region on the basis of the grapple operation region and the difference region. Therefore, the iron scrap classification apparatus 100 may determine a quadrangular region (unloading region B-box) including the unloading region determined along the boundary indicating the difference region to be a final region of interest. Since the classification information for the iron scraps is obtained by obtaining the segmented image of the region of interest for the unloading region determined along the boundary indicating the difference region, there is an advantage in that an error rate according to changes in a surrounding region other than the unloading region may be reduced.

The iron scrap classification apparatus 100 may determine the region of interest on the basis of an operating state of the grapple that indicates whether the grapple includes one or more iron scraps when the grapple is included in any partial region of regions of a vertical direction of the loading device for a preset period of time. For example, the iron scrap classification apparatus 100 may determine whether unloading of the iron scrap has occurred on the basis of a period of time during which the grapple is included in the partial region of the regions of the vertical direction of the loading device.

The iron scrap classification apparatus 100 may determine that unloading of the one or more iron scraps has occurred when the period of time during which the grapple is included in a certain region is greater than a first period of time. In an embodiment, the first period of time may be a preset period of time to correspond to the case in which unloading of the iron scrap has occurred during the unloading process. Further, the partial region may include a plurality of regions that are updated as the grapple moves. Therefore, the iron scrap classification apparatus 100 may determine that unloading of the iron scrap has occurred when a total period of time for each period of time during which the grapple is included in each of the plurality of partial regions is greater than or equal to the first period of time.

Further, the iron scrap classification apparatus 100 may determine a region among a plurality of regions that have the longest period of time for including the grapple to be the unloading region. That is, in an embodiment, the first period of time may be a period of time that serves as a criterion for determining whether unloading of the iron scrap has occurred. The iron scrap classification apparatus 100 may obtain the operating state of the grapple that indicates whether the grapple includes one or more iron scraps for each of a plurality of loaded state images captured during the unloading process when the grapple is included in a certain region for a second period of time longer than the first period of time by a preset period of time or more (e.g., half of the period of time of the first period of time). The case in which the period of time during which the grapple is included in the partial region is greater than or equal to the second period of time may be a situation in which it may be determined that no unloading has occurred.

For example, the second period of time is a period of time greater than or equal to the first period of time by the preset period of time or more, and there is a high probability that the case in which the period of time during which the grapple is included in the partial region is greater than or equal to the second period of time corresponds to a situation in which a current operation of the grapple is being performed in real time. Therefore, the iron scrap classification apparatus 100 may obtain the operating state of the grapple and determine the region of interest on the basis of the operating state.

For example, it is possible to identify the loaded state image in which the grapple includes one or more iron scraps among the plurality of loaded state image by obtaining the operating state of the grapple. The iron scrap classification apparatus 100 may determine a certain boundary region in which the grapple is located at a time point at which the operating state of the grapple first includes the iron scrap to be the region of interest, or determine a certain boundary region in which the grapple is located at a time point at which the operating state of the grapple last includes the iron scrap to be the region of interest.

The case in which the period of time during which the grapple is included in the partial region is greater than or equal to the second period of time may correspond to the case in which the grapple stays in the region of the vertical direction of the loading device for a long period of time. That is, the case in which there is a loaded state image in which the grapple includes one or more iron scraps may correspond to the case in which the grapple changes the positions of the plurality of iron scraps, rather than the case in which the grapple unloads the plurality of iron scraps from the loading device. Therefore, the iron scrap classification apparatus 100 may determine the region of interest on the basis of the first and last time points at which the grapple includes the iron scrap.

The region of interest corresponding to the first time point may be analyzed similarly to a state in which some iron scraps are unloaded, and the region of interest corresponding to the last time point may be analyzed similarly to a state in which some iron scraps are loaded. Therefore, the iron scrap classification apparatus 100 may determine the region of interest for the region in which the iron scrap is unloaded on the basis of a case in which the grapple stays in the region of the vertical direction of the loading device and then disappears, and determine the region of interest for the region in which the iron scrap is moved on the basis of the operating state of the grapple in the case in which the grapple stays in the region of the vertical direction of the loading device for the second period of time or more. Therefore, analysis and classification can be effectively performed on each of the plurality of iron scraps, regardless of their positioning in various situations.

In another embodiment, the iron scrap classification apparatus 100 may obtain an operation pattern on the basis of the operating state of the grapple. For example, when the period of time during which the grapple is included in the partial region is greater than or equal to the second period of time, the iron scrap classification apparatus 100 may analyze a plurality of consecutively captured loaded state images to determine whether the operating state of the grapple is repeated between a state that includes iron scrap and a state that does not include iron scrap. When an operation pattern in which a state that includes iron scrap and a state that does not include iron scrap repeatedly occur is obtained, the iron scrap classification apparatus 100 may determine the positions and number of regions of interest differently on the basis of the sequential positions of the state that includes iron scrap and the state that does not include iron scrap according to the number of repetitions and the passage of time.

For example, since the case in which the number of repetitions is 1 means that the positions of some iron scraps among the plurality of iron scraps has been moved once, the iron scrap classification apparatus 100 may determine the number of regions of interest to be two, and determine the positions of the regions of interest to be a region corresponding to the position of the grapple for the period of time during which the grapple first includes the iron scrap and a region corresponding to the position of the grapple for the period of time during which the grapple last includes the iron scrap.

Further, the size of the region of interest may be determined according to a change between a previous loaded state image (image before being updated) and a current loaded state image (updated image). The iron scrap classification apparatus 100 may update the region of interest on the basis of the probability of overlap between two regions of interest when the number of repetitions is 1. For example, when the sequential positions of the state that includes the iron scrap and the state that does not include the iron scrap are less than a preset distance (e.g., less than a length corresponding to 10 percent of the horizontal length of the loading device), the iron scrap classification apparatus 100 may perform a first image analysis by overlapping two regions of interest and updating the two regions of interest to one region of interest, perform a second image analysis on the two regions of interest, and perform a third image analysis by subdividing the two regions of interest and updating the two regions of interest to three regions of interest.

Specifically, when the sequential positions of the state that includes the iron scrap and the state that does not include the iron scrap are less than the preset distance, the iron scrap classification apparatus 100 may provide classification information for iron scraps through the third image analysis process. Since the probability of overlap between the regions of interest is high in the case in which the sequential positions are less than the preset distance, two regions of interest may overlap and be determined to be one region of interest, and item information and grade information for each target iron scrap, which is one among the plurality of iron scraps, may be obtained based on the layer information.

Further, analysis may be performed on each of the two regions of interest to obtain the item information and grade information for each target iron scrap. Further, analysis may be performed on each of three regions of interest divided based on a distance between the centers of the grapple in the states that include and does not include the iron scrap and the length that is ⅓ of the average of the preset distances, to obtain the item information and grade information for each target iron scrap. Therefore, by comparing and analyzing results of the analysis of the third image analysis process, the accuracy of the analysis for each target iron scrap can be enhanced.

In another embodiment, when the number of repetitions is two or more, the iron scrap classification apparatus 100 may determine that it is not a situation in which a process of analyzing a state similar to that in which some iron scraps are unloaded for one region of interest and analyzing a state similar to that in which some iron scraps are loaded for another region of interest is not applicable, as described above. That is, when the number of repetitions is two or more, the iron scrap classification apparatus 100 may determine that it is the case of mixing a plurality of iron scraps, and the case of not corresponding to unloading and/or loading. Therefore, when the number of repetitions is two or more, the iron scrap classification process may be terminated, and the iron scrap classification process may be re-performed by resetting at a time point at which the grapple is no longer included in some regions (when the grapple disappears).

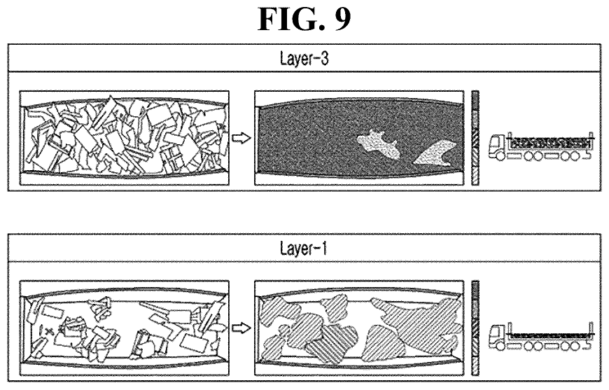

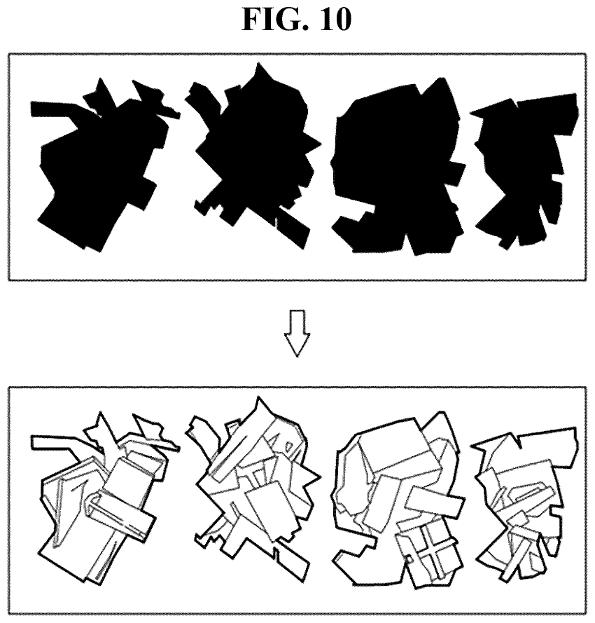

FIG. 9 is a diagram illustrating an example in which the iron scrap classification apparatus 100 obtains layer information for each layer change time point using the stereo type method.

Referring to FIG. 9, the iron scrap classification apparatus 100 may obtain a first layer change time point at which the height of a plurality of iron scraps is changed by a critical height or more on the basis of depth information obtained using the stereo type method. Further, the iron scrap classification apparatus 100 may obtain a second layer change time point at which the volume of the plurality of iron scraps is changed by a critical percentage or more on the basis of the average volume of the loading device. Therefore, the iron scrap classification apparatus 100 may obtain layer information on the basis of at least one of the first layer change time point and the second layer change time point.

In an embodiment, the iron scrap classification apparatus 100 may perform a layer change measurement process. A layer may be a concept of a unit corresponding to a layer of iron scrap that has changed after at least one iron scrap has been unloaded using a grapple. For example, a case in which iron scrap is fully loaded onto the loading device may be referred to as Layer-3, and a case in which iron scrap is loaded onto the loading device beyond the height of the loading device may be referred to as Layer-3.5. Further, at the time point at which the height of the iron scrap in the loading device is changed to the critical height or more during the unloading process, the layers may be updated to a lower layer, e.g., Layer-2 or Layer-1, one by one.

In an embodiment, when the item information and grade information for the target iron scrap are determined using the layer information determined based on the depth information obtained using the stereo type method, there is an advantage in that it is less sensitive to changes such as movement or the like and there is time between layers, so that a higher-level AI or machine learning may be applied.

As illustrated in FIG. 9, when the plurality of iron scraps are fully loaded onto the loading device, the iron scrap classification apparatus 100 may determine the layer as Layer-3. As the loaded height decreases, it may determine subsequent layers as lower layers. In Layer-1 shown in FIG. 9, it can be seen that the height of the plurality of loaded iron scraps is lower and the volume of the plurality of iron scraps is smaller, and in Layer-3 shown FIG. 9, it can be seen that the height of the plurality of loaded iron scraps is higher and the volume of the plurality of iron scraps is larger.

The iron scrap classification apparatus 100 may obtain a depth map for each layer to obtain the depth information. In an embodiment, when it is assumed that an average unloading period of time is about 5 minutes (300 seconds), unloading is performed about 20 times with the grapple, and the layers are approximately 3 layers, the item information and the grade information should be inferred within 15 seconds (300 seconds/20 times) when the item information and the grade information are determined in units of grapples. On the other hand, the item information and the grade information should be determined within 100 seconds (300 seconds/3 layers) when the item information and the grade information are determined in units of layers, and thus there is an advantage in that a higher-level AI or machine learning application is possible.

In an embodiment, the iron scrap classification apparatus 100 may determine a time point at which the height of the plurality of iron scraps decreases to a critical height (or more about 0.4 m) to be the first layer change time point. Further, the iron scrap classification apparatus 100 may obtain average volume information on the loading device from an administrator account. The iron scrap classification apparatus 100 may determine a time point at which the volume of the plurality of iron scraps decreases to a critical percentage or more (about 33 percent) based on the average volume of the loading device on the basis of the obtained average volume of the information to be the second layer change time point. Therefore, the iron scrap classification apparatus 100 may determine the layer at any time point that is faster in temporal order on the basis of the first layer change time point and/or the second layer change time point, or at the average time point of the first layer change time point and the second layer change time point.

The iron scrap classification apparatus 100 may obtain the item information and grade information for the target iron scrap by further utilizing the depth information obtained from at least one determined layer in analyzing a segmented image. That is, the change between the respective updated images for each layer may be measured based on the layer change time points.

In another embodiment, the iron scrap classification apparatus 100 may assign different sizes of weights to the first layer change time point and the second layer change time point. For example, the iron scrap classification apparatus 100 may use the layer information, and the weights may be assigned at a ratio of 7:3 to each of the first layer change time point and the second layer change time point because the importance of the height (depth) may be higher than the importance of the volume. Further, the iron scrap classification apparatus 100 may determine the ratio differently according to an initial loaded state in which the plurality of iron scraps are loaded. For example, the importance of the height (depth) may be determined differently according to the loading height according to the initial loaded state.

For example, when the plurality of iron scraps are loaded to correspond to 100% of the height of the loading device on the basis of the initial loaded state, the weights may be assigned at a ratio of 8:2 to the first layer change time point and the second layer change time point. When the plurality of iron scraps are loaded to correspond to 90% or more of the height of the loading device, the weights may be assigned at a ratio of 7:3 to the first layer change time point and the second layer change time point. When the plurality of iron scraps are loaded to correspond to 80% or more and less than 90% of the height of the loading device, the weights may be assigned at a ratio of 6:4 to the first layer change time point and the second layer change time point. When the plurality of iron scraps are loaded to correspond to less than 80% of the height of the loading device, the weights may be assigned at a ratio of 5:5 to the first layer change time point and the second layer change time point. Therefore, since the average time point at which a layer is obtained is determined by updating a ratio at which the weight is assigned so that the importance of the volume relative to the length may be increased according to the loading height of the loading device, the efficiency of utilizing the layer information can be improved.

In another embodiment, the iron scrap classification apparatus 100 may determine the importance of the volume differently according to the size of the loading device. For example, when the total volume of the loading device is less than a preset volume, the sensitivity of volume may be high, and thus the weights may be assigned at a ratio of 3:7 to the first layer change time point and the second layer change time point. Further, when the total volume of the loading device is greater than a certain multiple (3 times) of the preset volume, the critical height and the critical percentage may be updated. For example, when the total volume of the loading device is greater than a certain multiple, the height may not be reduced much even when a large amount of iron scrap is unloaded, and thus the critical height may be reduced to a length corresponding to 80% of the conventional critical height (e.g., about 0.32 m), and the critical percentage may be increased to a percentage corresponding to 120% of the conventional critical percentage (e.g., about 39.6 percent). Therefore, the efficiency can be improved because the sensitivity of height and volume may be adjusted according to the situation. Each of the above-described numbers and percentages may be changed flexibly according to the situations, and may also be changed and set by the administrator.

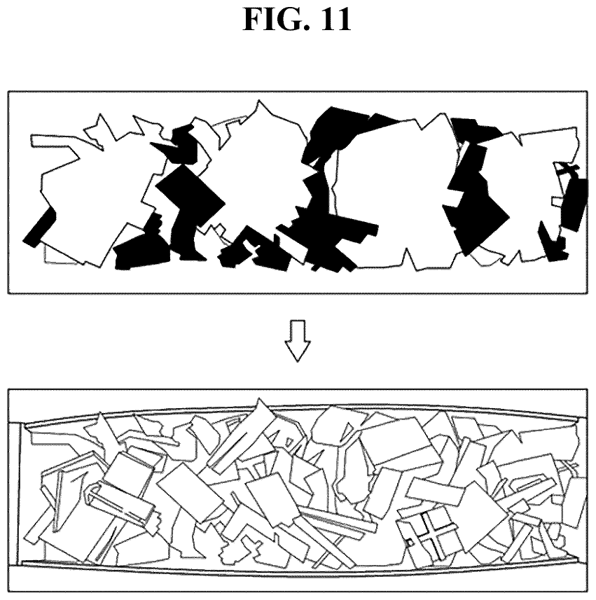

FIG. 10 is a diagram illustrating an example in which the iron scrap classification apparatus 100 performs semantic segmentation and instance segmentation.

Referring to FIG. 10, the iron scrap classification apparatus 100 may perform instance segmentation, which segments objects of the same type into the same region, and/or perform instance segmentation, which segments objects of the same type into different regions, thereby segmenting the types and boundary lines of objects in an image. That is, the type and position of iron scrap may be obtained from the loaded state image using an AI learning model, and item information and grade information for each iron scrap may be obtained.

The iron scrap classification apparatus 100 may perform semantic segmentation and instance segmentation in parallel. That is, the instance segmentation may be performed after the semantic segmentation is performed, or the semantic segmentation may be performed after the instance segmentation is performed. For example, as illustrated in FIG. 10, the iron scrap classification apparatus 100 may obtain a segmented image of a single object by performing the semantic segmentation, which segments iron scrap into the same region when the iron scraps are of the same type and performing the instance segmentation, which segments each of segmented images for aggregate objects on which the semantic segmentation has been performed into different iron scrap regions one by one.

As illustrated in FIG. 10, the iron scrap classification apparatus 100 may perform the semantic segmentation that labels (or segments) a plurality of iron scraps into aggregate objects, and perform the instance segmentation that labels (or segments) the plurality of iron scraps into each single object. Further, conversely, the iron scrap classification apparatus 100 may perform the semantic segmentation on a region from which a region corresponding to a single object is excluded after image segmentation for the single object is performed by performing the instance segmentation. Therefore, this approach enhances accuracy by obtaining more segmented images for aggregate objects, even in regions in which the instance segmentation has not been performed accurately. This will be described with reference to FIG. 11.

FIG. 11 is a diagram illustrating an example in which the iron scrap classification apparatus 100 further obtains segmented images for aggregate objects for a region from which a region corresponding to a single object is excluded.

Referring to FIG. 11, the iron scrap classification apparatus 100 may obtain a segmented image of aggregate objects by performing the semantic segmentation on a region from which a region corresponding to a single object obtained according to the instance segmentation in FIG. 10 is excluded. Therefore, after the semantic segmentation is performed, the instance segmentation may be further performed on the region corresponding to the aggregate objects. Therefore, as shown at a lower part of FIG. 11, a region of each of a plurality of iron scraps may be further segmented into a single object even for the region from which the region corresponding to the single object is excluded.

In FIG. 11, although an example in which the semantic segmentation and the instance segmentation are performed on a plurality of iron scraps throughout a loading device is described, but the present disclosure is not limited thereto, and the semantic segmentation and the instance segmentation may be equally applied to a region of interest.

As described above, the iron scrap classification apparatus 100 obtains the segmented images for the region of each of the plurality of iron scraps using the semantic segmentation and the instance segmentation in parallel, and thus the accuracy of the item information and grade information for each target iron scrap can be enhanced.

According to an embodiment, by performing image analysis and image classification using a segmentation model and a classification model, the accuracy of iron scrap classification can be enhanced by obtaining segmented images for both single objects and aggregate objects. Further, the accuracy of image classification and analysis for an unloading region can be improved by obtaining layer information using mono type and stereo type methods. The accuracy of detecting the unloading region can be further enhanced by determining a region of interest on the basis of a grapple operation region. Further, by obtaining segmented images using semantic segmentation and instance segmentation in parallel, it is possible to compensate for inaccuracies in regions where each segmentation has not been performed effectively.

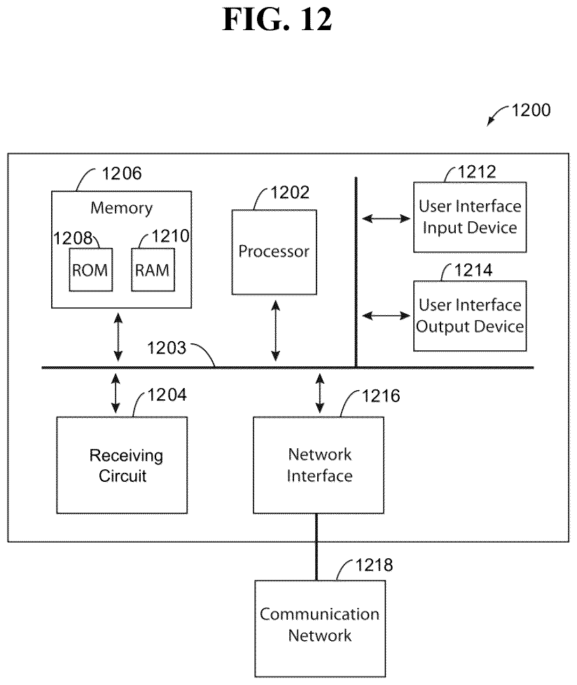

FIG. 12 shows a simplified diagram of a device 1200 that corresponds to the device 100 illustrated in FIG. 1, according to an embodiment of the present disclosure. The device 1200 comprises a processor 1202 and a receiving circuit 1204 that are in communication with each other via a bus 1203. The device 1200 may also include a memory 1206. The memory 1206 may include a Read Only Memory (ROM) 1208 and a Random Access Memory (RAM) 1210. The device 1200 may further include a user interface input device 1212 (e.g., a keyboard, mouse, or touch screen) and a user interface output device 1214 such as a display screen. In an implementation, the user interface input device 1212 and the user interface output device 1214 may be integrated together, e.g., a touch display screen. A network interface 1216 is configured to allow information to be communicated between the device 1200 and a loading device (not shown) via a communications network 1218.

Various embodiments of the present disclosure may be implemented as software including one or more instructions stored in a storage medium (e.g., a memory) that can be read by a machine (e.g., a display device or a computer). For example, a processor (e.g., the processor 120) of the machine may call at least one of the stored instructions from the storage medium and execute the instructions. This enables the device to operate to perform at least one function in accordance with the at least one called instruction. The one or more instructions may include code generated by a compiler or code executable by an interpreter. The storage medium readable by the device may be provided in the form of a non-transitory storage medium. Here, the term “non-transitory” means only that the storage medium is a tangible device and does not contain signals (e.g., electromagnetic waves), and this term does not distinguish between a case where data is stored semi-permanently and a case where data is stored temporarily in the storage medium.

According to an embodiment, the method according to various embodiments disclosed in the present disclosure may be included in a computer program product and provided. The computer program product may be traded between a seller and a buyer as a commodity. The computer program product may be distributed in the form of a machine-readable storage medium (e.g., a compact disc read-only memory (CD-ROM)), or may be distributed online (e.g., by download or upload) through an application store (e.g., Play Store™) or directly between two user devices (e.g., smartphones). In the case of online distribution, at least a portion of the computer program product may be temporarily stored or temporarily generated in a machine-readable storage medium, such as a memory of a manufacturer's server, an application store's server, or an intermediary server.

According to an embodiment of the present disclosure, image analysis and image classification using a segmentation model and a classification model can enhance the accuracy of iron scrap classification by obtaining segmented images for both single objects and aggregate objects.

Further, the accuracy of image classification and analysis for an unloading region can be improved by obtaining layer information using both mono type and stereo type methods.

Further, the accuracy of detecting the unloading region can be further enhanced by determining a region of interest on the basis of a grapple operation region.

Further, by utilizing semantic segmentation and instance segmentation in parallel, it is possible to compensate for inaccuracies in regions where each segmentation has not been performed effectively.

Effects of the present disclosure are not limited to the above-described effects and other effects that are not described may be clearly understood by those skilled in the art from the above detailed descriptions.

While the present disclosure has been described with reference to the accompanying drawings, it is not limited to the disclosed embodiments and drawings, and it will be understood by those skilled in the art that various changes in form and details may be made without departing from the spirit and scope of the present disclosure. Therefore, the disclosed methods should be considered from an exemplary point of view for description rather than a limiting point of view. Even when the embodiments are described and the effects according to the configuration of the present disclosure are not explicitly described, effects that may be predicted by the configuration may also be recognized. The scope of the present disclosure is defined not by the detailed description of the present disclosure but by the appended claims and encompasses all modifications and equivalents that fall within the scope of the appended claims and will be construed as being included in the present disclosure.

What is claimed is:

1. A method of providing classification information for iron scraps according to an unloading process, the method comprising:
receiving, by a receiving circuit, a loaded state image from a camera during an unloading process of a plurality of iron scraps loaded onto a loading device;
obtaining, by a processor, layer information that is updated as the unloading process progresses and determined based on a height of the plurality of iron scraps, wherein the height is determined in a stack direction of the plurality of iron scraps loaded onto the loading device;
determining, by the processor, a region of interest based on the loaded state image that is updated as the unloading process progresses;
generating, by the processor, a segmented image of a target iron scrap, which is included in the region of interest, wherein the target iron scrap is one of the plurality of iron scraps;
generating, by the processor, item information and grade information for the target iron scrap based on the segmented image and the layer information; and
providing, by the processor, classification information for the iron scraps, including the item information and the grade information.

2. The method of claim 1, wherein a method of obtaining the layer information includes a mono type method in which one camera is used or a stereo type method in which two or more cameras are used, and
in the mono type method, depth information obtained through analysis of changes in wall surface of a loading box obtained from an image obtained by the one camera is used.

3. The method of claim 1, wherein the determining of the region of interest includes determining, by the processor, the region of interest based on a result of comparing a first loaded state image corresponding to a first time point with a second loaded state image corresponding to a second time point that is temporally later than the first time point.

4. The method of claim 3, wherein the determining of the region of interest includes determining, by the processor, the region of interest based on a difference region between the first loaded state image and the second loaded state image and an operation region of a grapple used in the unloading process.

5. The method of claim 1, wherein:
the generating of the segmented image by the processor includes generating the segmented image that includes the target iron scrap from the loaded state image using a segmentation model; and
the generating of the item information and the grade information by the processor includes generating the item information and the grade information for the target iron scrap using a classification model that performs analysis in units of images.

6. The method of claim 5, wherein the generating of the segmented image includes:
performing, by the processor, instance segmentation on the loaded state image to generate a segmented image of a single object; and
performing, by the processor, semantic segmentation on the loaded state image to generate a segmented image of aggregate objects.

7. The method of claim 6, wherein the generating of the segmented image of the aggregate objects is performed on regions of the loaded state image, from which a region corresponding to the single object is excluded.

8. The method of claim 2, wherein, in the stereo type method, the depth information obtained through analysis of changes in angles obtained from images for a same region that are obtained from the two or more cameras positioned on a same plane is used.

9. The method of claim 4, wherein:
the second time point is determined based on whether the grapple is included in any partial region of regions of a vertical direction of the loading device after the first time point; and
the determining of the region of interest includes, when the grapple is included in the partial region for a preset period of time or more, determining, by the processor, the region of interest based on an operating state of the grapple that indicates whether the grapple includes at least one iron scrap.

10. The method of claim 8, wherein the method of obtaining the layer information includes:
obtaining, by the processor, a first layer change time point at which the height of the plurality of iron scraps are changed to a critical height or more based on the depth information obtained using the stereo type method;
obtaining, by the processor, a second layer change time point at which a volume of the plurality of iron scraps are changed to a critical percentage or more based on an average volume of the loading device; and
obtaining, by the processor, the layer information at at least one of the first layer change time point and the second layer change time point.

11. An iron scrap classification apparatus for providing classification information for iron scraps according to an unloading process, the apparatus comprising:
a receiving circuit configured to receive a loaded state image from a camera during an unloading process of a plurality of iron scraps loaded onto a loading device; and
a processor that is configured to:
obtain layer information that is updated as the unloading process progresses and determined based on a height of the plurality of iron scraps, wherein the height is determined in a stack direction of the plurality of iron scraps loaded onto the loading device;
determine a region of interest based on the loaded state image that is updated as the unloading process progresses;
generate a segmented image of a target iron scrap, which is included in the region of interest, wherein the target iron scrap is one of the plurality of iron scraps;
generate item information and grade information for the target iron scrap based on the segmented image and the layer information; and
provide classification information for the iron scraps, including the item information and the grade information.

12. The apparatus of claim 11, wherein a method of obtaining the layer information includes a mono type method in which one camera is used or a stereo type method in which two or more cameras are used, and
in the mono type method, depth information obtained through analysis of changes in wall surface of a loading box obtained from an image obtained by the one camera is used.

13. The apparatus of claim 11, wherein the processor determines the region of interest based on a result of comparing a first loaded state image corresponding to a first time point with a second loaded state image corresponding to a second time point that is temporally later than the first time point.

14. The apparatus of claim 13, wherein the processor determines the region of interest based on a difference region between the first loaded state image and the second loaded state image and an operation region of a grapple used in the unloading process.

15. A computer-readable recording medium on which a program is recorded, the program comprising instructions that, when executed by a processor, cause the processor to:
when receiving a loaded state image from a camera during an unloading process of a plurality of iron scraps loaded onto a loading device,
obtain layer information that is updated as the unloading process progresses and determined based on a height of the plurality of iron scraps, wherein the height is determined in a stack direction of the plurality of iron scraps loaded onto the loading device;
determine a region of interest based on the loaded state image that is updated as the unloading process progresses;
generate a segmented image of a target iron scrap, which is included in the region of interest, wherein the target iron scrap is one of the plurality of iron scraps;
generate item information and grade information for the target iron scrap based on the segmented image and the layer information; and
provide classification information for the iron scraps, including the item information and the grade information.

16. The computer-readable recording medium of claim 15, wherein a method of obtaining the layer information includes a mono type method in which one camera is used or a stereo type method in which two or more cameras are used, and
in the mono type method, depth information obtained through analysis of changes in wall surface of a loading box obtained from an image obtained by the one camera is used.

17. The computer-readable recording medium of claim 15, wherein the instructions causes the processor to determine the region of interest based on a result of comparing a first loaded state image corresponding to a first time point with a second loaded state image corresponding to a second time point that is temporally later than the first time point.

18. The computer-readable recording medium of claim 17, wherein the instructions causes the processor to determine the region of interest based on a difference region between the first loaded state image and the second loaded state image and an operation region of a grapple used in the unloading process.
